(19) United States
(12) Patent Application Publication
(10) Pub. No.: US 2010/0236027 A1
(43) Pub. Date: Sep. 23, 2010

(54) CLOSURE DEVICE

(76) Inventors: Andrew Barker, Afton, MN (US); Joshua Marrow, Jersey City, NJ (US)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/708,613

(22) Filed: Feb. 19, 2010

Related U.S. Application Data
(60) Provisional application No. 61/153,745, filed on Feb. 19, 2009.

(51) Int. Cl. B65D 33/16; A44B 19/24; B23P 17/04

(52) U.S. Cl. 24/30.5 L; 29/428

(57) ABSTRACT

A closure device for closing a bag, includes a rail assembly having a first and a second rail, each rail having a proximal and a distal end, the respective proximal rail ends being operably coupled together and the respective distal rail ends being openable to define an aperture between the first and a second rails, and a lock ring, the lock ring having a bore defined therethrough, the rail assembly being disposable in the bore, the lock ring being readily shiftable along a dimension of the rail assembly, the dimension extending from proximate the proximal end of the rail assembly to proximate the distal end of the rail assembly. A method of forming a closure device id further included.

### RELATED APPLICATION

The present application claims the benefit of U.S. Provisional Application No. 61/153,745 filed Feb. 19, 2009, and included herein in its entirety by reference.

### TECHNICAL FIELD

The present invention relates to a closure device for closing an opened bag of product. More particularly, the present invention relates to a reusable closure device for an opened bag.

### BACKGROUND OF THE INVENTION

There are many instances in which a bag of material is opened, a portion of the material is withdrawn, and the remainder of the material is left in the bag. In the past, spring loaded clips that act on a central pivot have been available for closing the opened bag as desired. Such clips have not proved totally satisfactory. The closing power of such a clip is depended upon the tension in the spring and the lever arm that the spring works upon. This limits the use of such clips to whether small, light bags, such as may be used for snack products including potato chips and the like. Additionally, such clips are of a length that is typically less than the width dimension of the bags sought to be closed.

Accordingly, there is a need in the industry for a closure device for opened bags that extends the full width of the bag to be closed and may be sized appropriately for heavy bags as well as light bags. Such a device should be effective for closing a wide range of bags including from food products, hardware products, fertilizer/gardening products, pet food, medical products, industrial products and the like.

### SUMMARY OF THE INVENTION

The present invention is a closure device for temporarily closing opened bags. The closure device of the present invention is capable of being sized to temporarily close rather small, light bags, such as for snack food, and for closing rather large heavy bags, such as fertilizer, pet food, medical products and industrial products. Additionally, the length of the closure device of the present invention may be readily adapted to fully close a variety of bags of varying widths, material thickness, and construction material.

The present invention is a closure device for closing a bag, including a rail assembly having a first and a second rail, each rail having a proximal and a distal end, the respective proximal rail ends being operably coupled together and the respective distal rail ends being openable to define an aperture between the first and a second rails, and a lock ring, the lock ring having a bore defined therethrough, the rail assembly being disposable in the bore, the lock ring being readily shiftable along a dimension of the rail assembly, the dimension extending from proximate the proximal end of the rail assembly to proximate the distal end of the rail assembly. The present invention is further a method of forming a closure device.

### BRIEF DESCRIPTION OF THE DRAWINGS

FIG. 1 is a side elevational view of the closure device of the present invention disposed on an opened bag;

FIG. 2 is an elevational view of forming the rail member of the closure device;

FIG. 3 is an end elevational view of the closure device;

FIG. 4 is a perspective view of the lock ring member of the closure device;

FIG. 5 is a perspective view of the rail member;

FIG. 6 is an end elevational view of the closure device supported by a handle;

FIG. 7 is an end elevational view of the interface of the handle loops with the closure device;

FIG. 8 is a perspective view of the closure device depending from the handle;

FIG. 9 is a side elevational view of a rack supporting a closure device and bag

FIG. 10 is a bottom plan form view of the rack of FIG. 9;

FIG. 11 is a perspective view of another embodiment of the closure device;

FIG. 12 is an end elevational view of the rail member of the device of FIG. 11 depicting two rails in the closed, mated disposition;

FIG. 13 is an end elevational view of the rail member of the device of FIG. 11 depicting two rails in the open, splayed disposition;

FIG. 14 is an end elevational view of the rail member of the device of FIG. 11 depicting two rails in the closed, mated disposition;

FIG. 15 is a perspective view of the lock ring member of the device of FIG. 11;

FIG. 16 is a side elevational view of the lock ring member of the device of FIG. 11;

FIG. 17 is a sectional view of the lock ring member of the device of FIG. 11;

FIG. 18 is a perspective view of another embodiment of the closure device having a split lock ring member, the split lock ring member being in an open, unlocked disposition;

FIG. 19 is a perspective view of the closure device of FIG. 18 having a split lock ring member, the split lock ring member being in an closed, locked disposition;

FIG. 20 is an end elevational view of another embodiment of the closure device depicting the lock ring member in the shiftable disposition with respect to the rail member;

FIG. 21 is an end elevational view of the closure device of FIG. 20 depicting the lock ring member in the locked disposition with respect to the rail member;

FIG. 22 is a top planform view of the rail member of another embodiment of the closure device;

FIG. 22a is an end elevational view of the rail member of FIG. 22;

FIG. 23 is a side elevational view of the rail member of the closure device of FIG. 22;

FIG. 24 is a sectional view of the rail member of the closure device as depicted at A of FIG. 22;

FIG. 25 is a top planform view of the rail member hinge of the closure device as depicted at B of FIG. 22;

FIG. 26 is a perspective view of a further embodiment of the closure device in the open, splayed disposition, the rails each having a single flute;

FIG. 27 is a top planform view of the closure device of FIG. 26 in the open, splayed disposition;

FIG. 28 is a sectional view of the rail member of the closure device as depicted at A-A of FIG. 22;

FIG. 29 is a perspective view of a further embodiment of the closure device in the open, splayed disposition wherein the two rails each have two flutes;

FIG. 30 is a top planform view of the closure device of FIG. 29 in the open, splayed disposition;

FIG. 31 is a sectional view of the rail member of the closure device as depicted at A-A of FIG. 30;

FIG. 32 is a perspective view of a further embodiment of the closure device in the open, splayed disposition wherein each of the two rails has a multi-faceted outer margin;

FIG. 33 is a top planform view of the closure device of FIG. 29 in the open, splayed disposition;

FIG. 34 is a sectional view of the rail member of the closure device as depicted at A-A of FIG. 30;

FIG. 35 is a top planform view of a further embodiment of the closure device in the open, splayed disposition each of the rails having a semi-circular outer margin;

FIG. 36 is a sectional view of the rail member of the closure device as depicted at A-A of FIG. 35; and

FIG. 37 is a sectional view of the rail member of the closure device as depicted at A-A of FIG. 35.

### DETAILED DESCRIPTION OF THE DRAWINGS

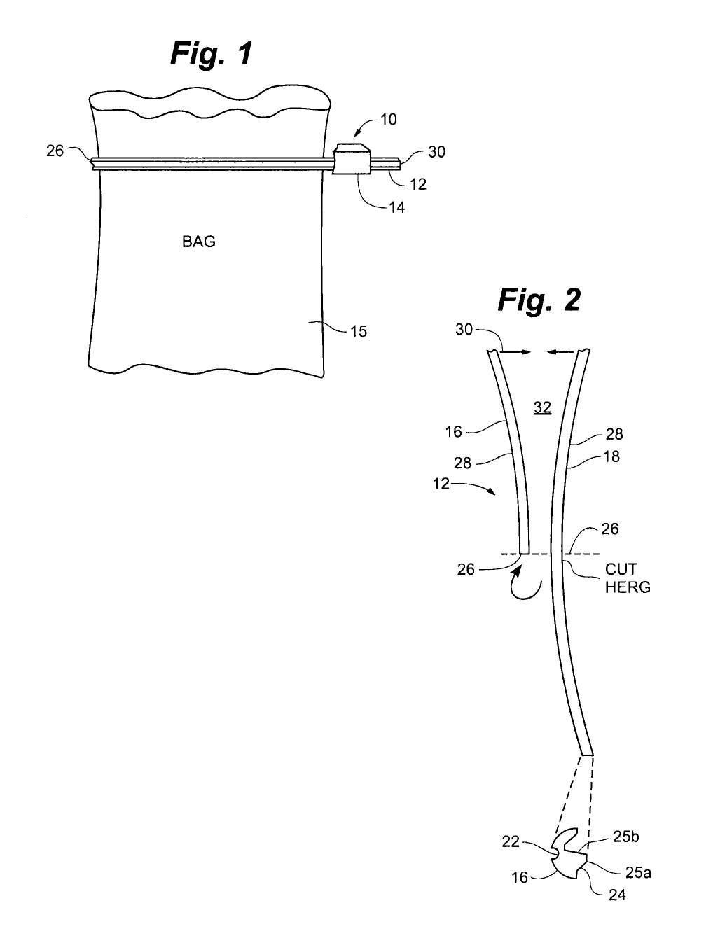

The closure device of the present invention is shown generally at 10 in the figures. The closure device 10 includes two major subcomponents, rail member 12 and a lock ring member 14. As depicted in FIG. 1, the closure device 10 is employed closing an opened bag 15.

Referring to FIG. 2, the rail member 12 is formed of two opposed and identical rails, first rail 16 and second rail 18. Each of the rails 16, 18 can be formed of a single extrusion, cut to an appropriate length and then disposed in an opposed relationship to form the rail member 12. Preferably, the extruded material forming the rails 16, 18 is food safe, recycled, flexible, resilient, and splinter/shatter proof. The rails 16, 18 may be formed of metal for heavy industrial applications or plastic for lighter applications.

Each of the respective rails 16, 18 of the exemplary rail member 12 depicted in FIGS. 3 and 5 has a semi-circular (in cross-section) outer margin 20 such that when the two rails 16, 18 are mated together a generally circular outer margin is presented. The outer margin 20 of the respective rails 16, 18 may be other shapes than semicircular such as oval, race track, and the like, as noted below. A semi-circular elongate groove 22, extending the full length dimension of the rail member 12 is formed in each of the respective rails 16, 18. An outward directed opening 23 is defined in each of the grooves 22, extending the full length of the respective groove 22.

The inner margin of the respective rails 16, 18 is defined by a zigzag shaped surface. Other conforming shapes may be used as noted above. The zigzagged surface 24 preferably has an elevated portion 25a and an adjacent valley 25b. When the rails 16, 18 are mated together, the elevated portion 25a of a rail 16, 18 resides in the valley 25b of the other rail 16, 18. The inner margins of the respective rails need not be zigzagged, but must be conforming. As such, the inner margins can be other shapes, including flat.

As depicted in FIG. 2, the rail member 12 is fixedly coupled at a proximal end 26. Such coupling can be affected in a number of ways, including fusing, bonding, welding, hinging (noted below) and insertion of the respective ends 26 into a cup-like end device.

The single extruded or injection molded strand that forms the respective rail 16, 18 is formed with an inherent curve in it such that when the rails 16, 18 are mated together at the proximal end 26, the respective rails 16, 18 have an outward directed (splayed) curvature 28. Brining the rails 16, 18 together in a mated disposition generates tension, help in to close the bag 15. The curvature 28 acts to define a generally spread apart open distal end 30. An interface aperture 32, as depicted in FIGS. 2 and 7 is defined between the splayed rails 16, 18.

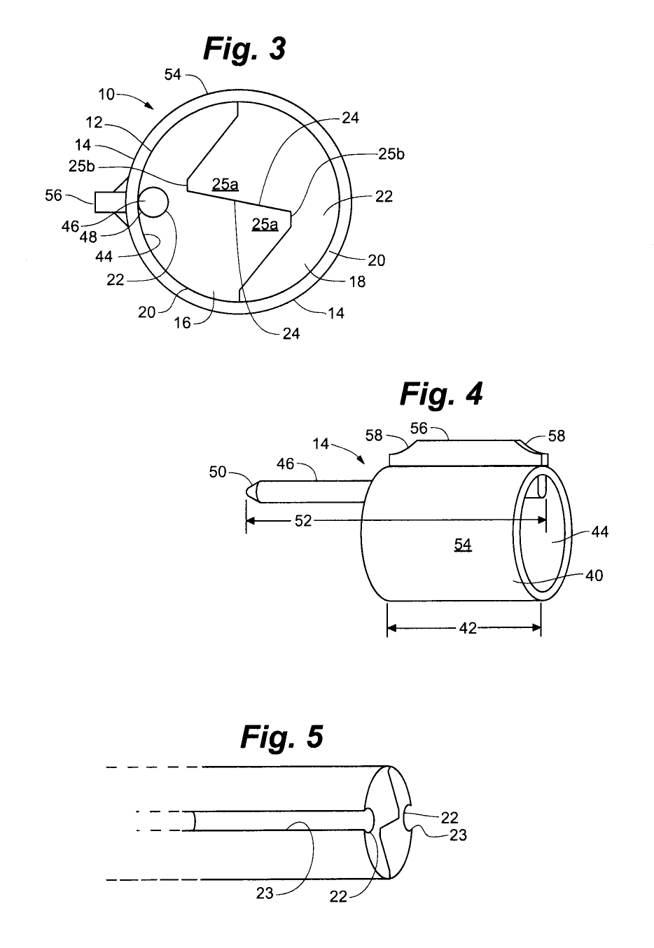

The second subcomponent member of the closure device 10 is the lock ring member 14. As depicted in FIGS. 3 and 4, the exemplary lock ring member 14 has a tubular structure 40. In this embodiment, the shape of the bore 44 of the lock ring member 14 is dictated by the exterior marginal shape of the rail member 12 when the rails 16, 18 are mated. Accordingly, if the exterior margin of the rail member 12 is oval in shape, the bore 44 of the lock ring member 14 is also oval in shape. The structure 40 has a selected length dimension 42. A one of the rails 16, 18 is shorter than the other rail 16, 18 by a length dimension that is equal to or greater than the length dimension 42 so that the lock ring member 14 may be parked at the distal end 30 of the longer of the two rails 16, 18, thereby leaving the distal end 30 of the shorter of the two rails 16, 18 free of the lock ring member 14 for allowing ready insertion of the bag 15 between the rails 16, 18.

The bore 44 defining the inner margin of the structure 40 is preferably slightly larger than the outer margin of mated rails 16, 18 such that the lock ring member 14 may readily slide over the rail member 12 with and without a bag 15 captured therebetween.

Optionally, a spear 46 is fixedly coupled to a margin of the bore 44 at a tangential joint 48. The spear 46 has a length dimension 52 that is substantially greater than the length dimension 42 such that the spear 46 projects beyond the tubular structure 40. The spear 46 is terminated at its distal end with a tapered tip 50.

The outer margin 54 of the structure 40 is generally circular in cross-section. An outward directed tab 56 is fixedly coupled to the structure 40 opposite to the spear 46. The tab 56 may have beveled or curved corners 58.

In operation, the opened bag 15 (see FIG. 1) is entered into the interface aperture 32 and preferably is slid up proximate the fixedly coupled end 26. The opened end 30 of the rail member 12 is then closed manually and the lock ring member 14 is mated to the rail member 12. This is affected by aligning the spear 46 with a groove 22 and inserting the spear 46 into the groove 22. The lock ring member 14 may be then slid over the rail member 12 to a disposition proximate the edge of the bag 15.

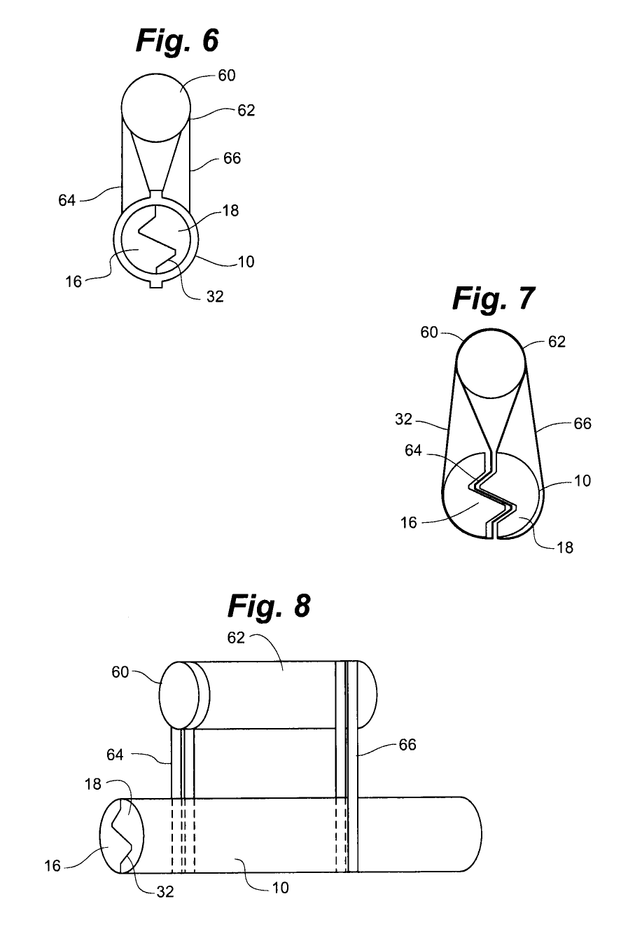

Referring to FIGS. 6-8, a handle member 60 may be employed with the closure device 10. The handle member 60 is preferably an elongate rod 62 that has at least two depending loops 64, 66. In operation, the loop 64 is passed through the interface aperture 32 and around the first rail 16. The loop 66 is also passed through the interface aperture 32 and then around the second rail 18. In this way, the bag 15 can also be passed into the interface aperture 32 and held therein by the lock ring member 14. In such disposition, the handle 60 may be utilized to carry the bag 15 depending from the closure device 10.

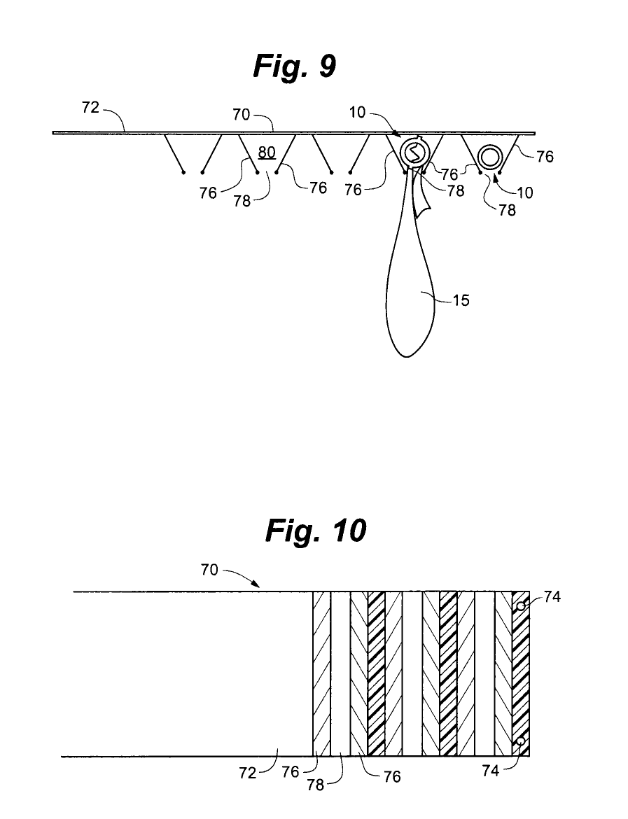

A rack 70 for use with the closure device 10 is depicted in FIGS. 9 and 10. The rack 70 is comprised of a panel 72 having a plurality of bores 74 defined therein. Fastening devices such as screws may be passed through the bores 74 to adhere the rack 70 to the underside of a shelf. Sets of inward directed fingers 76 depend from the panel 72. Each set of inward directed fingers 76 defines an opening 78. The fingers 76 are rigid and fixedly coupled to the panel 72. In operation, closure devices 10 may be stored in the generally V-shaped space 80 defined between respective fingers 76 of the finger pair 76. Additionally, a closure device 10 in a closing disposition with a bag 15 may also be disposed in the space 80 for storage of the depending bag 15.

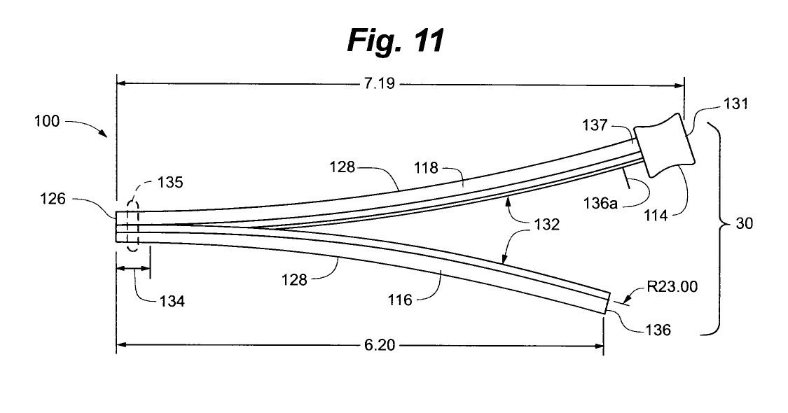

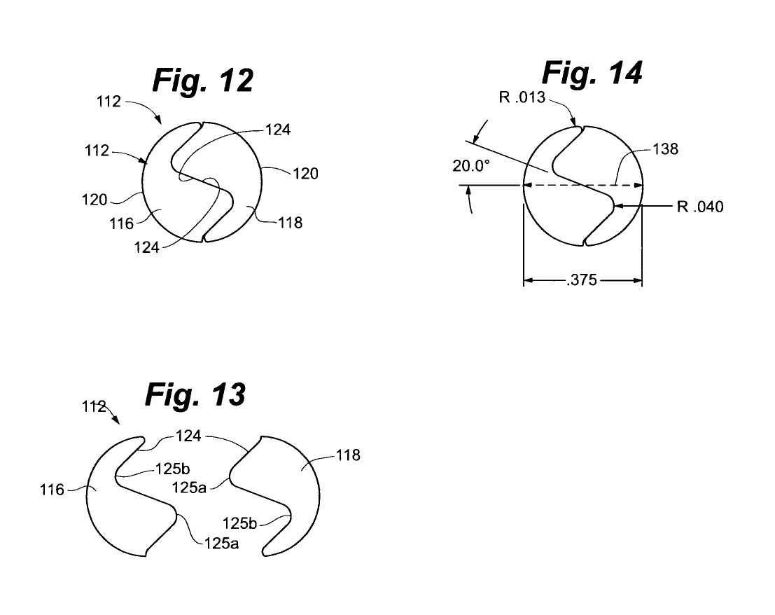

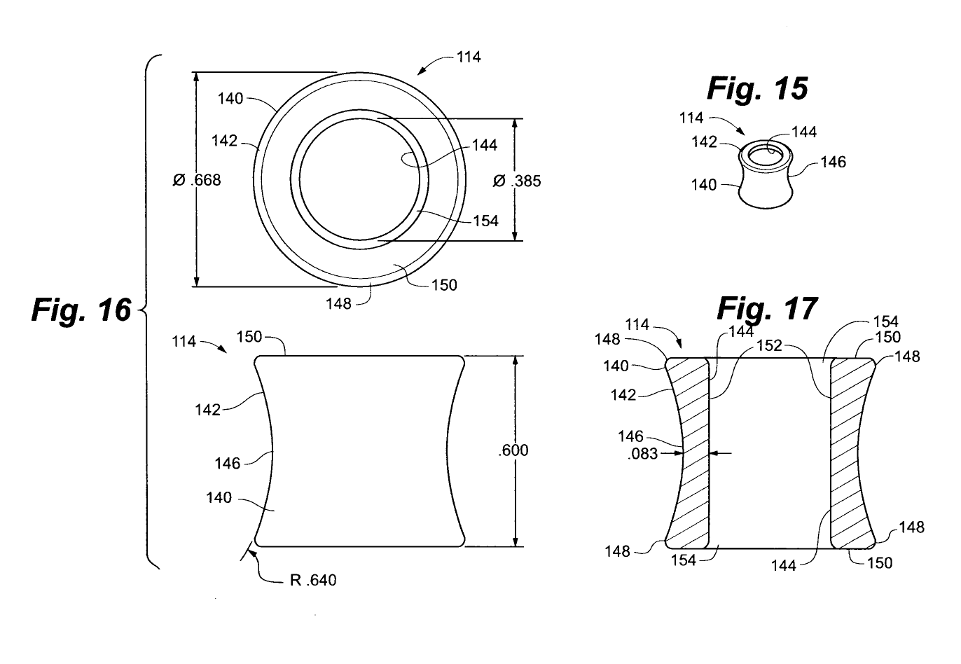

A further embodiment of the closure device of the present invention is depicted generally at 100 in FIGS. 11-17. Closure device 100 has two major subcomponents; rail member 112 and lock ring member 114.

Referring to FIGS. 11-14, the rail 112 includes a first rail 116 and a second rail 118. As noted in FIG. 11, the first rail 116 is shorter than the second rail 118. Each of the rails 116, 118 has a generally semicircular outer margin 120. The inner margin 124 of the rails 116, 118 defines a generally zigzag pattern. The inner margins 124 have a peak portion 125a and a valley portion 125b. It should be noted that the inner margin 124 of the first rail 116 is inverted with respect to the inner margin 124 of the second rail 118. In this manner, the two rails 116, 118 are mateable together, the peak portion 125a of the first rail 116 residing in the valley portion 125b of the second rail 118 and conversely, the peak portion 125a of the second rail 118 residing in the valley portion 125b of the first rail 116 when the two rails 116, 118 are mated together. This means of rail mating is applicable to all the embodiments of the closure device presented herein. But other shapes of the inner margins 124 are clearly possible as long as the shape of the respective inner margins 124 is conforming.

The two rails 116, 118 have a fixedly coupled end 126. The two rails 116, 118 are fixed together at the fixedly coupled end 126 by means of bonding, welding, fusing, or the like. Preferably, such fixing extends for a relatively short fixed region 134 of the total length of the rails 116, 118. A ring 135 may be brought into compressive engagement with the region 134 to further strengthen the region 134, as desired. The ring 135 may be made of metal or nylon or the like.

The rails 116, 118 may be formed of nylon, plastic or the like. Preferably, the rails 116, 118 are formed by extrusion and more preferably by injection molding. In formation, the rails 116, 118 may be made identically. Each of the rails 116, 118 is formed with an outward (splaying) curvature. When coupled at the fixedly coupled proximal end 126, the rails 116, 118 are outwardly splayed toward the open distal end 130 to define an interface aperture 132 between the respective rails 116, 118, the aperture 132 for receiving the bag 15.

A stop 131 is disposed at the open end 130 of the longer of the two rails 116, 118, the second rail 118 in this case. The stop 131 is sufficiently large to prevent removing the lock ring member 114 from the rail 18.

As noted in FIG. 11, when the interface aperture 132 is closed and the two rails 116, 118 are mated together, the end 136 of the first rail 116 comes to the position noted at 136a, thereby leaving seat 137 for parking the lock ring member 114 at the distal end second rail 118. When mated together, the two rails 116, 118 have a diameter 138 as depicted in FIG. 14.

The lock ring member 114 of the closure device 100 is depicted in FIGS. 13-17. The lock ring 114 has a generally tubular structure 140. A tube 142 has a bore 144 defined therethrough. The exterior margin of the tube 142 has a centrally disposed shallow waist 146 that facilitates manually grasping the lock ring member 114. A circular rounded corner 148 connects the waisted outer margin of the tube 142 to the planar ends 150.

The bore 144 has a generally constant diameter 152. A beveled surface 154 is disposed at the respective ends of the bore 144. The diameter 152 is somewhat greater than the diameter 138 so that the lock ring 114 is free to translate on the rail 112 when the rails 116, 118 are in their mated disposition.

In operation, a bag 15 (as depicted in FIG. 1) may be slipped into the open end 130 when the rails 116, 118 are in their splayed disposition, the bag 15 then residing in the interface aperture 132. At this point, the lock ring 114 is parked on the lock ring seat 137 and retained in that disposition by the stop 131. The rails 116, 118 are then manually brought into the mated disposition proximate the open end 130. In such disposition, the lock ring 114 may be slid over the rail member 112 toward the fixedly coupled proximal end 126, thereby capturing the rails 116, 118 together and capturing the bag 15 between the first rail 116 and the second rail 118.

To disengage the closure device 100 from the bag 15, the lock ring 114 is merely slid to the right in the depiction of FIG. 17 until the lock ring 114 disengages the shorter first rail 116 and the rails 116, 118. The rails 116, 118, being resilient and having a shape memory, return to their splayed disposition, thereby releasing the bag 15. The resiliency and shape memory of the rails 116, 118 imparts a splaying bias to the rails 116, 118.

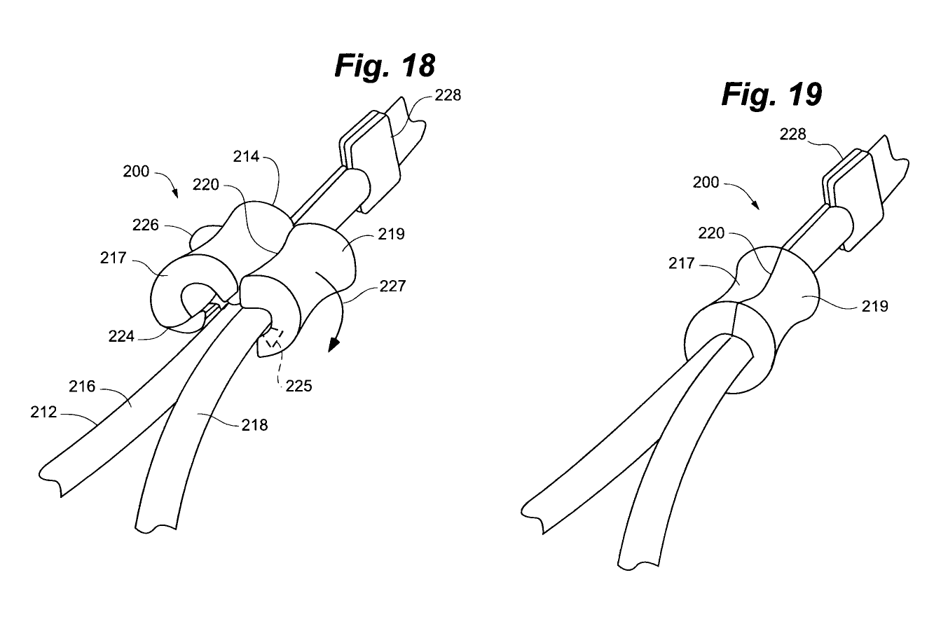

Another embodiment is depicted in FIGS. 18 and 19 wherein the closure device of the present invention is shown generally at 200. The closure device 200 includes two major subcomponents; rail member 212 and split lock ring member 214. The rail member 212 is formed of a first rail 216 and a second rail 218 formed in a manner similar to that above for rails 116, 118.

The split lock ring 214 has a first ring portion 217 and a second ring portion 219 coupled at a respective margin thereof by a hinge 220. A bore 222, similar to the bore 144 of the embodiment described above, is defined through the split lock ring 214 when the ring portions 217, 219 are in their mated disposition, as depicted in FIG. 19.

The first ring portion 217 has a biased clasp 224 coupled to a manually operatable release 226. The second ring portion 219 has a notch 225 defined in the exterior margin thereof.

In operation, the split lock ring 214 in the disengaged disposition of FIG. 18 is placed over the splayed rails 216, 218. Finger pressure is indicated by arrow 227 pivots the ring portions 217, 219 about the hinge 220, thereby bringing the rails 216, 218 into closer engagement. As the ring portions 217, 219 are brought together to form the singular tubular device, the biased clasp 214 engages the notch 225 and holds the split lock ring 214 in the engaged disposition of FIG. 19.

To release the rail 212, an operator actuates the release 226, thereby withdrawing the clasp 224 from the notch 225. The splaying bias of the rails 216, 218 forces the ring portions 217, 219 into the disengaged disposition, thereby releasing the rail 212 from the split lock ring 214.

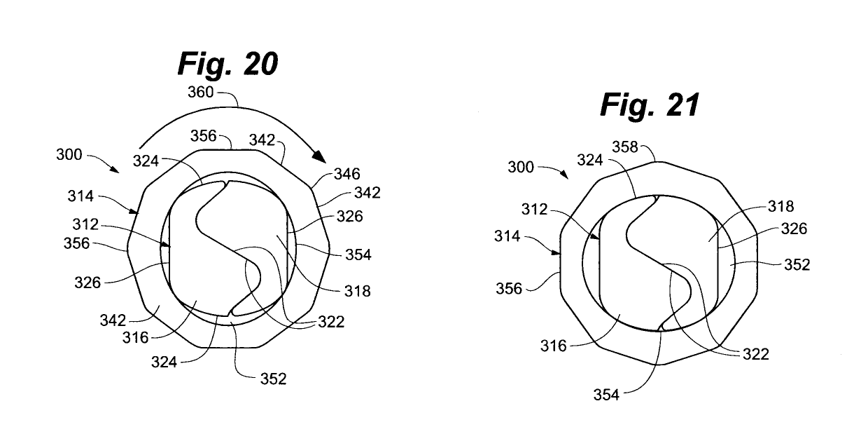

Yet another embodiment is depicted in FIGS. 20 and 21, wherein the closure device of the present invention is depicted generally at 300. Closure device 300 has two major subcomponents; split rail member 312 and lock ring member 314. Closure device 300 may be defined as an interference rail and lock ring. This is a departure from the other embodiments in which the shape of the inner margin of the lock ring member mimics the shape of the outer margin of the rail member.

Split rail member 312 includes a first rail 316 and a mateable second rail 318. Each of the rails 316, 318 has an outer margin 320 and a zigzag shaped inner margin 322. The respective outer margins 320 of the rails 316, 318 generally define a race track pattern when the rails 316, 318 are mated together. As such, the respective outer margins 320 have curved ends 324 coupled to straight sides 326 by means of shoulders 328.

The lock ring 314 is generally a tubular structure 340 wherein the outer margin of the tube 342 is defined by adjacent straight segments 344 wherein shoulders 346 are defined at the intersection of adjacent straight segments 344. In the depictions of FIGS. 20 and 21, the lock ring 314 has ten such straight sides 326. A greater or lesser number of straight sides 326 may be utilized as desired.

A bore 348 is defined in the tubular structure 340. The bore 348 is oval in cross-section as depicted at 350. Oval cross-section 350 has a greater dimension 352 and a lesser dimension 354. In the depiction of FIG. 20, the greater dimension 352 of the oval cross-section 350 is depicted along a vertical axis and the lesser dimension 354 is depicted along a horizontal axis.

In the depiction of FIG. 21, the greater dimension 352 of the oval cross-section 350 is indicated along a horizontal axis and the lesser dimension 354 is depicted along a vertical axis. The greater dimension 352 and the lesser dimension 354 are readily ascertainable in FIGS. 20 and 21 by means of an area of diminished wall thickness 356 corresponding to the greater dimension 352 and a relatively greater wall thickness 358 that corresponds to the lesser dimension 354.

In operation, the lock ring 314 captures the split rail 312, thereby forcing the rails 316, 318 into their mated disposition as depicted in FIGS. 20 and 21. As depicted in FIG. 20, the lock ring 314 may be readily slid along the split rail 312 with the wall of the bore 348 contacting only the shoulders 346. When the lock ring 314 and split rail 312 are in the desired disposition relative to one another, the lock ring 314 may be rotated a quarter of a turn as indicated by the arrow 360 from the disposition of FIG. 20 to the disposition of FIG. 21. In the depiction of FIG. 21, the lesser dimension 354 of the bore 348 is in engagement with the respective curved ends 324 of the rails 316, 318, thereby holding the rails 316, 318 in their engaged, mated disposition.

To unlock the closure device 300, the lock ring 314 is rotated opposite to the direction of the arrow 360 a quarter of a turn, thereby shifting the lock ring 314 from the disposition of FIG. 21 to the disposition of FIG. 20 in which the lock ring 314 may be readily slid along the split rail 312 to provide for splaying of the rails 316, 318.

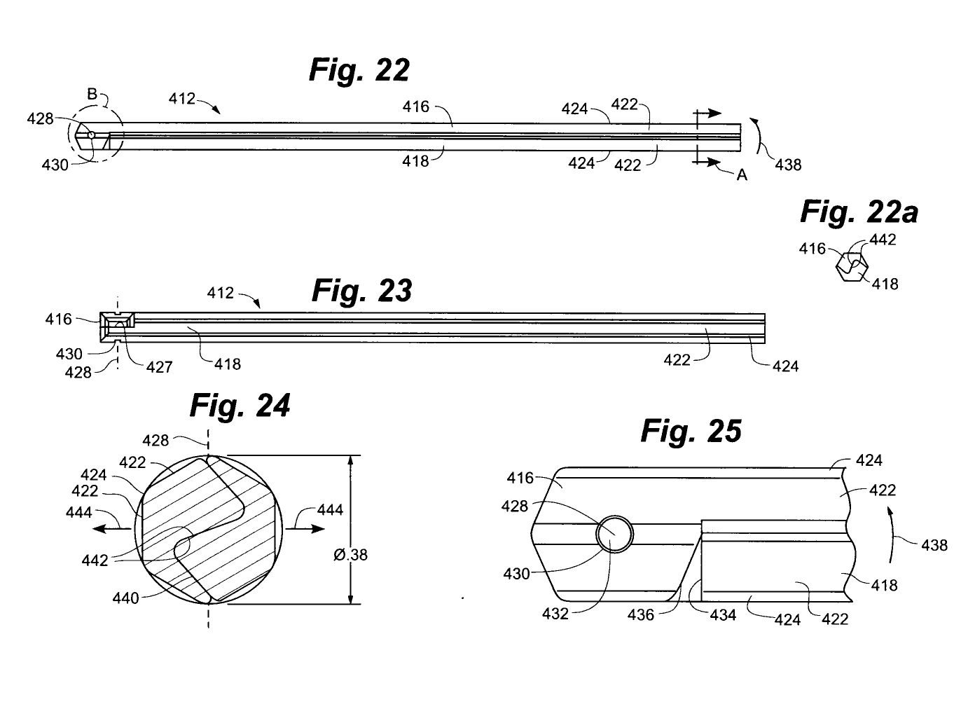

A further embodiment of the closure device of the present invention is shown generally at 400 in FIGS. 22-25. In this embodiment, a distinguishing feature of the closure device 400 is the fact that the two rails are coupled at an end by means of a hinge.

As with the embodiments described above, the closure device 400 includes two major subcomponents; rail member 412 and lock ring member 414. The first rail 416 and the second rail 418, are each formed with an exterior margin 420 that is comprised of a series of straight segments 422 joined by shoulders 424. As noted in FIG. 24, when the rails 416, 418 are mated together, the exterior margin of the rail member 412 has a generally hexagonal shape. It is to be understood that fewer or more straight segments 422 could be utilized as desired.

A stop 431 is disposed at the open end 430 of the longer of the two rails 416, 418, the second rail 418 in this case. The lock ring member 414 is parked abutting the stop 431.

A hinge 426 is provided at a proximal end of the rail member 412. The hinge 426 includes a mating interface 427 that is defined between respective components of the rails 416, 418 that form the hinge 426.

A transverse rotation axis 428 is defined through the hinge 426. The rotation axis 428 is coincident with a cylinder axis of a pin bore 430 and the longitudinal axis of a pin 432, the pin 432 being disposed in the pin bore 430.

As depicted in FIGS. 22 and 25, a transverse face 434 is defined proximate the proximal end of the second rail 418. An opposed angled face 436, defined proximate the proximal end of the first rail 416, is disposed opposite the transverse face 434. As will be noted below, the faces 434, 436 act as a stop limiting the opening of the rails 416, 418.

In operation, in order to capture a bag such as the bag 15, the respective rails 416, 418 are grasped and rotated about the axis 428 to a point in which the faces 434, 436 engage. Such action causes the respective rails 416, 418 to shift as depicted by the arrows 444. The interface 440 of the inner margins 442 of the respective rails 416, 418 is removed, such that an aperture such as the interface aperture 132 noted above is defined between the respective rails 416, 418. The bag 15 may then be inserted between the opened rails 416, 418 and captured therein by rotating the respective rails 416, 418 about the axis 428 opposite to the direction indicated by the arrows 444.

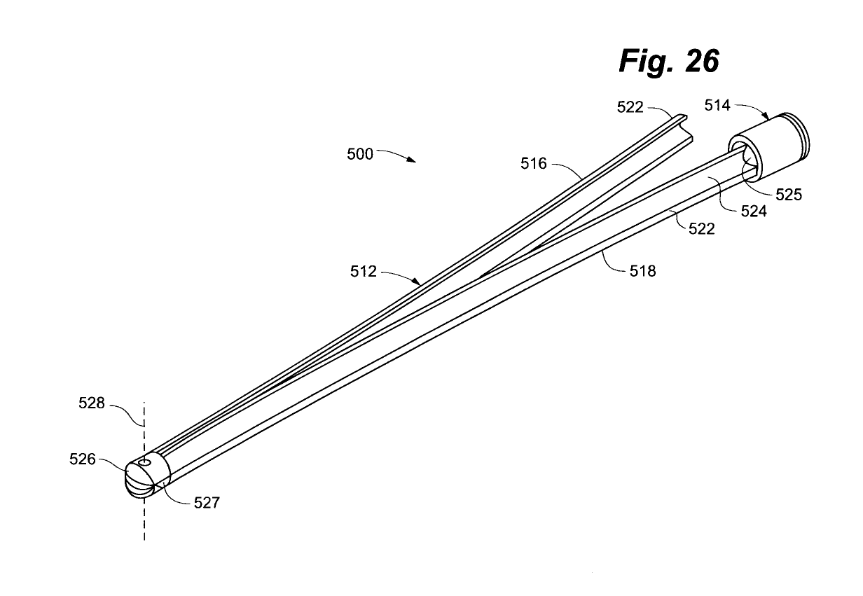

A further embodiment of the closure device of the present invention is shown generally at 500 in FIGS. 26-28. In this embodiment, a distinguishing feature of the closure device 500 is the fact that the two rails are coupled at an end by means of a hinge and the exterior margin of the two rails is fluted.

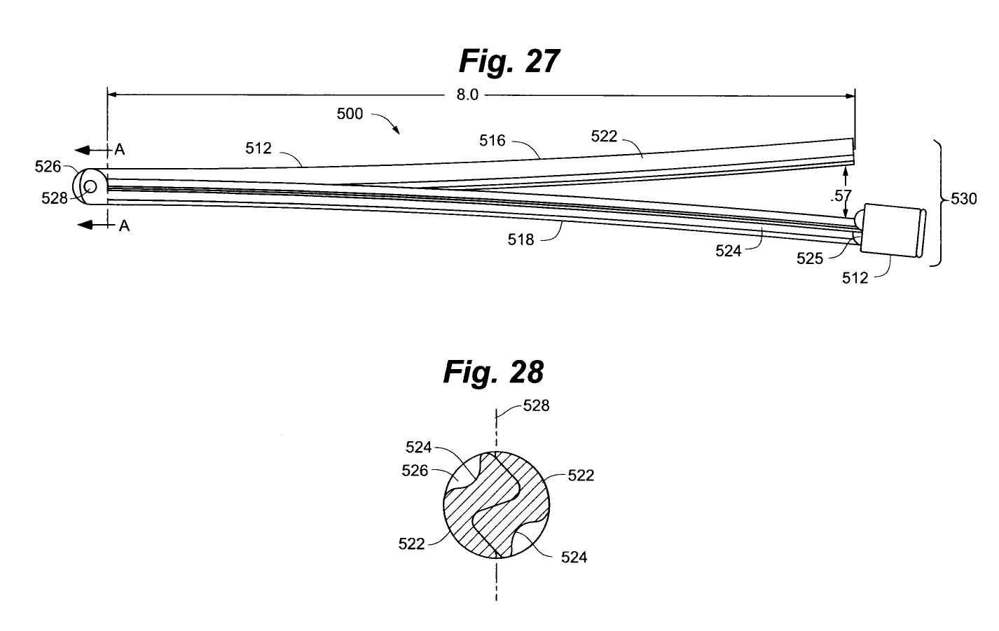

As with the embodiments described above, particularly closure device 400, the closure device 500 includes two major subcomponents; rail member 512 and lock ring member 514. The first rail 516 and the second rail 518 are each formed with an exterior margin 520 that is formed generally semicircular 522, interrupted by a flute 524. As noted in FIGS. 26 and 27, the inner margin 525 of the lock ring member 514 is fluted to inversely mimic the exterior margin of the rail member 512, as noted in FIG. 28. It is be understood that the radial dimensions of the inner margin 525 of the lock ring member 514 are slightly greater than the radial dimensions of the rail member 512 in order to facilitate the lock ring member translating along the rail member 512. It should be noted that more flutes 524 could be utilized as desired.

The interior margin 525 of the lock ring member 514 may be formed conformal with the exterior margin of the rail member 512. Alternatively, the distal end of rail 518 could be thickened and formed to conform to the circular inner margin of the lock ring member 514.

A stop 531 is disposed at the open end 530 of the longer of the two rails 516, 518, the second rail 518 in this case. The lock ring member 514 is parked abutting the stop 531.

A hinge 526 is provided at a proximal end of the rail member 512. The hinge 526 includes a mating interface 527 that is defined between respective components of the rails 516, 518 that form the hinge 526.

A transverse rotation axis 528 is defined through the hinge 526. The rotation axis 528 is coincident with a cylinder axis of a pin bore, as depicted at 430 above, and the longitudinal axis of a pin, as depicted at 432 above.

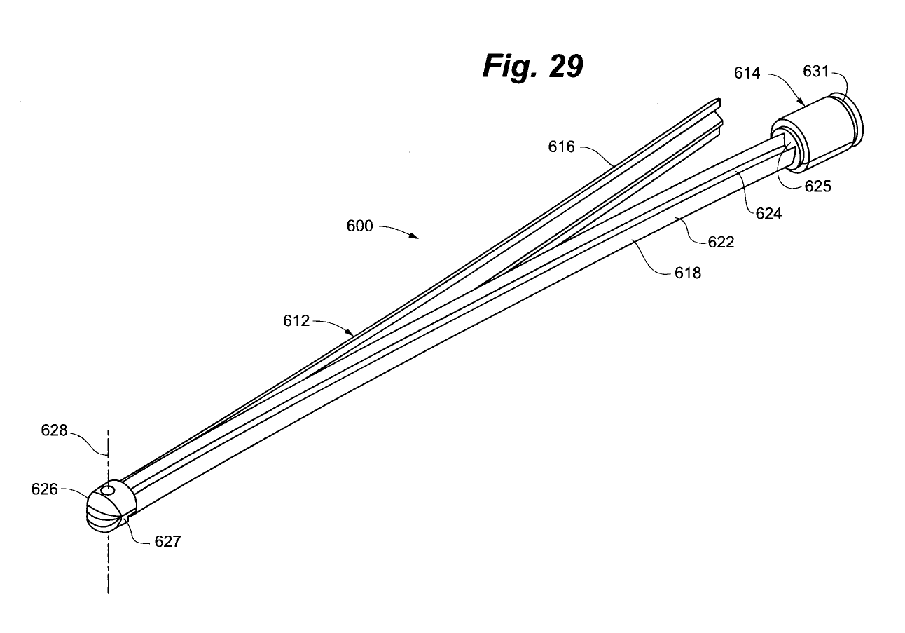

A further embodiment of the closure device of the present invention is shown generally at 600 in FIGS. 29-31. In this embodiment, a distinguishing feature of the closure device 400 is the fact that the two rails are coupled at an end by means of a hinge and the exterior margin of the two rails is fluted with two flutes to each rail.

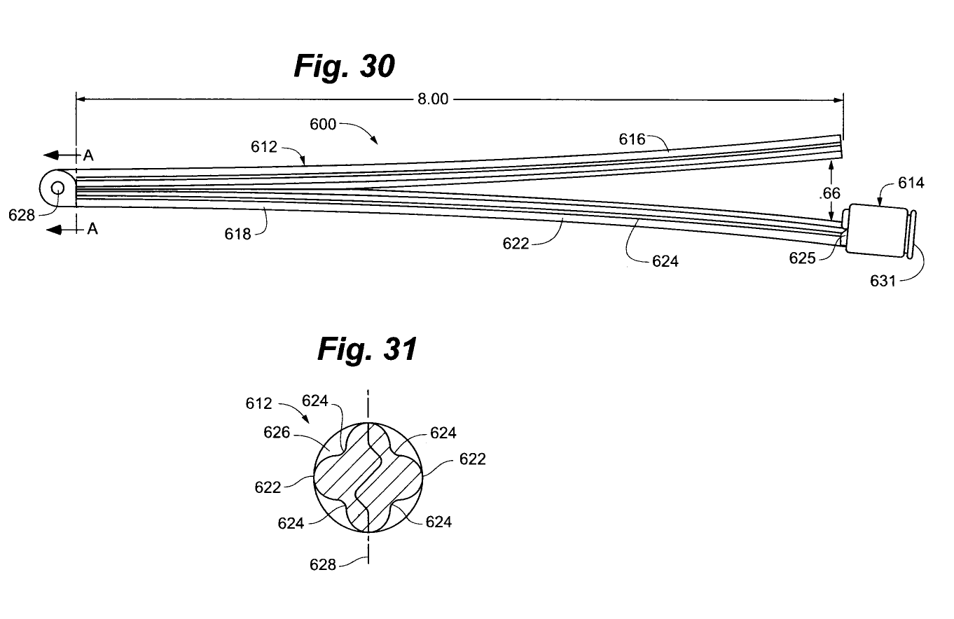

As with the embodiments described above, particularly closure device 400, the closure device 600 includes two major subcomponents; rail member 612 and lock ring member 614. The first rail 616 and the second rail 618 are each formed with an exterior margin 620 that is formed generally semicircular 622, interrupted by two flutes 624. As noted in FIGS. 29 and 30, the inner margin 625 of the lock ring member 614 is fluted to inversely mimic the exterior margin of the rail member 612, as noted in FIG. 31. It is be understood that the radial dimensions of the inner margin 625 of the lock ring member 614 are slightly greater than the exterior radial dimensions of the rail member 612 in order to facilitate the lock ring member 614 translating along the rail member 612. It should be noted that more flutes 624 could be utilized as desired.

A stop 631 is disposed at the open end 630 of the longer of the two rails 616, 618, the second rail 618 in this case. The lock ring member 614 is parked abutting the stop 631.

A hinge 626 is provided at a proximal end of the rail member 612. The hinge 626 includes a mating interface 627 that is defined between respective components of the rails 616, 618 that form the hinge 626.

A transverse rotation axis 628 is defined through the hinge 626. The rotation axis 628 is coincident with a cylinder axis of a pin bore, as depicted at 430 above, and the longitudinal axis of a pin, as depicted at 432 above.

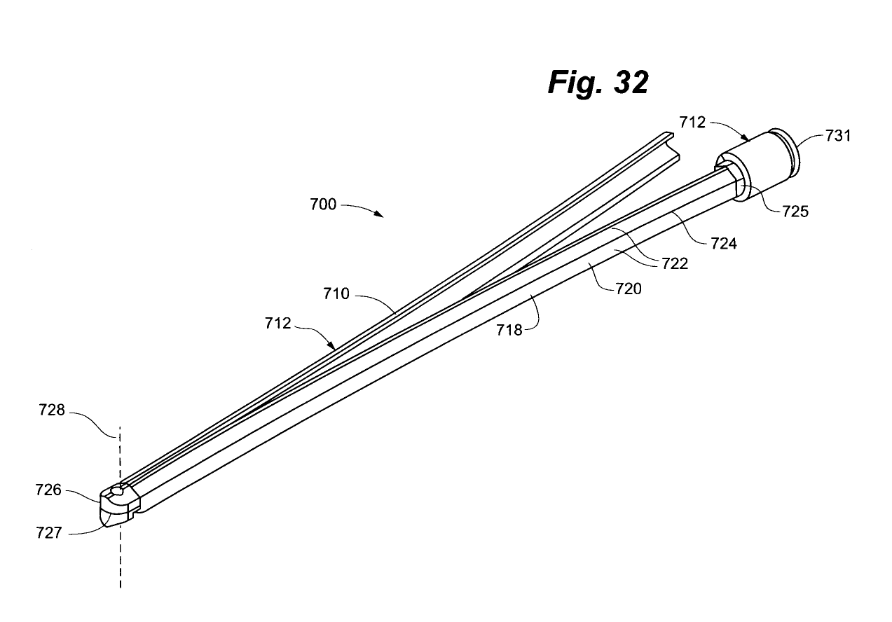

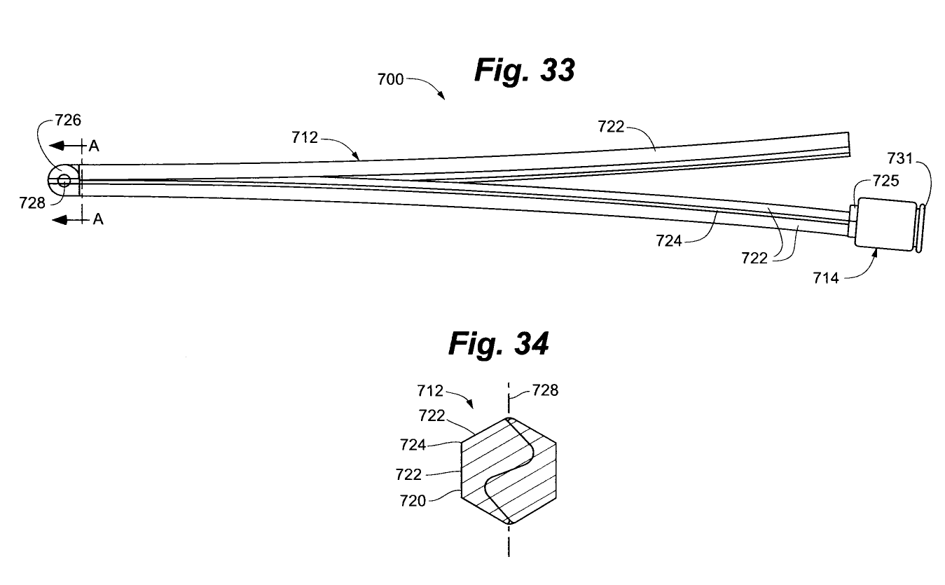

A further embodiment of the closure device of the present invention is shown generally at 700 in FIGS. 32-34. In this embodiment, a distinguishing feature of the closure device 700 is the fact that the two rails are coupled at an end by means of a hinge and the exterior margin of the two rails when mated is hexagonal with three faces to each rail.

As with the embodiments described above, particularly closure device 400, the closure device 700 includes two major subcomponents; rail member 712 and lock ring member 714. The first rail 716 and the second rail 718, are each formed with an exterior margin 720 that is formed generally hexagonal with adjacent faces 722, joined by a respective shoulder 724. As noted in FIGS. 29 and 30, the inner margin 725 of the lock ring member 614 is formed hexagonally to mimic the exterior margin 720 of the rail member 612, as noted in FIG. 31. It is be understood that the radial dimensions of the inner margin 725 of the lock ring member 714 are slightly greater than the exterior radial dimensions of the rail member 712 in order to facilitate the lock ring member 714 translating along the rail member 712. It should be noted that more faces 722 could be utilized as desired, such as in an octagonal shape.

A stop 731 is disposed at the open end 430 of the longer of the two rails 716, 718, the second rail 718 in this case. The lock ring member 714 is parked abutting the stop 731.

A hinge 726 is provided at a proximal end of the rail member 712. The hinge 726 includes a mating interface 727 that is defined between respective components of the rails 716, 718 that form the hinge 726.

A transverse rotation axis 728 is defined through the hinge 726. The rotation axis 728 is coincident with a cylinder axis of a pin bore, as depicted at 430 above, and the longitudinal axis of a pin, as depicted at 432 above.

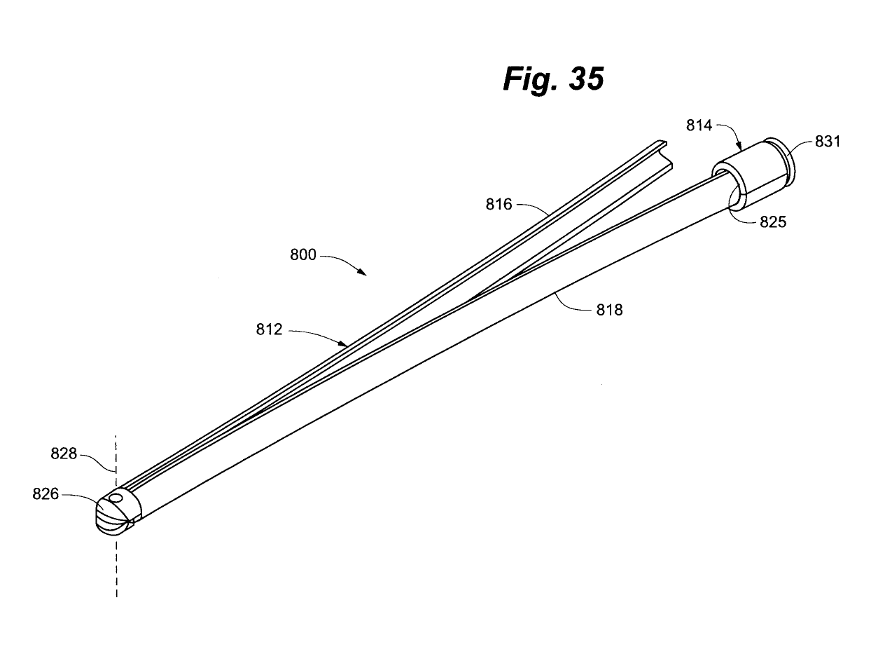

A final embodiment of the closure device of the present invention is shown generally at 800 in FIGS. 35-37. In this embodiment, a distinguishing feature of the closure device 800 is the fact that the two rails are coupled at an end by means of a hinge and the exterior margin of the two rails is semicircular.

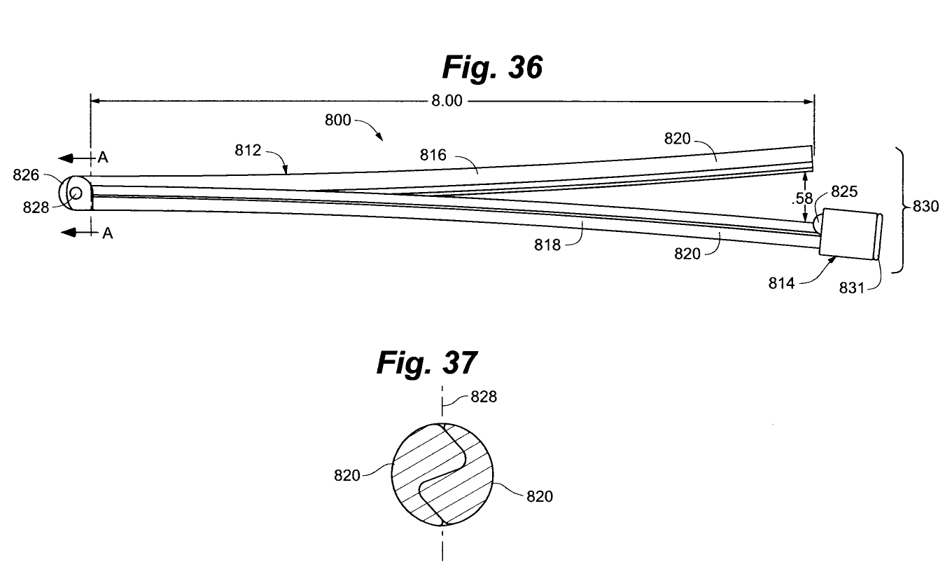

As with the embodiments described above, particularly closure device 400, the closure device 800 includes two major subcomponents; rail member 812 and lock ring member 814. The first rail 816 and the second rail 818 are each formed with an exterior margin 820 that is formed generally semi-circularly. As noted in FIGS. 35 and 36, the inner margin 825 of the lock ring member 814 is formed circularly to mimic the exterior margin 820 of the rail member 812, as noted in FIG. 7. It is be understood that the radial dimension of the inner margin 825 of the lock ring member 814 is slightly greater than the exterior radial dimensions of the rail member 812 in order to facilitate the lock ring member 814 translating along the rail member 812.

A stop 831 is disposed at the open end 830 of the longer of the two rails 816, 18, the second rail 818 in this case. The lock ring member 814 is parked abutting the stop 31.

A hinge 826 is provided at a proximal end of the rail member 812. The hinge 826 includes a mating interface 827 that is defined between respective components of the rails 816, 718 that form the hinge 726.

A transverse rotation axis 828 is defined through the hinge 826. The rotation axis 828 is coincident with a cylinder axis of a pin bore, as depicted at 430 above, and the longitudinal axis of a pin, as depicted at 432 above.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A closure device for closing a bag;
a rail assembly having a first and a second rail, each rail having a proximal and a distal end, the respective proximal rail ends being operably coupled together and the respective distal rail ends being openable to define an aperture between the first and a second rails, and;
a lock ring, the lock ring having a bore defined therethrough, the rail assembly being disposable in the bore, the lock ring being readily shiftable along a dimension of the rail assembly, the dimension extending from proximate the proximal end of the rail assembly to proximate the distal end of the rail assembly.

2. The closure device of claim 1 wherein each of the first and a second rails has material property characteristics described as resiliency and shape memory.

3. The closure device of claim 1 wherein each of the first and a second rails has a curved splaying shape when the respective rails are in a opened disposition.

4. The closure device of claim 1 wherein a one of the first and a second rails has a length dimension that is lesser than a length dimension of the second of the first and second rails.

5. The closure device of claim 1 wherein the lock ring has a certain axial dimension and wherein a one of the first and a second rails has a length dimension that is lesser than a length dimension of the second of the first and second rails by an amount equal to or greater than the certain axial dimension of the lock ring.

6. The closure device of claim 1 wherein the lock ring is parkable proximate a distal end of a longer of the first and a second rails.

7. The closure device of claim 1 wherein the lock ring is shiftable toward the distal ends of the respective rails from a parked disposition proximate a distal end of a longer of the first and a second rails.

8. The closure device of claim 1 wherein the lock ring is shiftable toward the distal ends of the respective rails from a parked disposition proximate a distal end of a longer of the first and a second rails, such shifting capturing the distal ends of both rails when the rails are brought into a mated disposition.

9. The closure device of claim 1 wherein each of the first and a second rails has an exterior margin that includes at least one flute.

10. The closure device of claim 1 wherein each of the first and a second rails has an interior margin that is formed in a conforming shape.

11. The closure device of claim 10 wherein the conforming shape is a zigzag shaped interior margin of the first rail is readily matable to the zigzag shaped interior margin of the second rail.

12. The closure device of claim 1 wherein each of the first and a second rails has a substantially identical cross sectional shape.

13. A closure device for closing a bag:
a first and a second rail being operably coupled together at a respective first rail end, the rails being splayed outward from the coupling to define an aperture between the first and a second rails, and;
shiftable engaging means for engaging the two rails in an engaged, mated disposition at a desired location along a respective length dimension of the two rails.

14. The closure device of claim 13 wherein each of the first and a second rails has an exterior margin that includes at least one flute.

15. The closure device of claim 13 wherein each of the first and a second rails has an interior margin that is formed in a zigzag shape.

16. The closure device of claim 15 wherein the zigzag shaped interior margin of the first rail is readily matable to the zigzag shaped interior margin of the second rail.

17. The closure device of claim 13 wherein each of the first and a second rails has a substantially identical cross sectional shape.

18. A method of forming a closure device, including:
forming a pair of rails in a substantially identical form with and with an interior margin that defines a zigzag shape;
operably coupling the two rails at a first end with the respective interior margins in an opposed facing disposition;
forming a lock ring with an axial bore therein; and
capturing the tow rails in a mated disposition with the lock ring.

19. The method of claim 18, including forming each of the first and second rails of a material having material property characteristics described as resiliency and shape memory.

20. The method of claim 18, including forming each of the first and second rails with at least one flute on a respective exterior rail margin.
